(19) United States
(12) Patent Application Publication
(10) Pub. No.: US 2019/0054567 A1
(43) Pub. Date: Feb. 21, 2019

(54) ADDITIVE MANUFACTURING SYSTEMS, ADDITIVE MANUFACTURED COMPONENTS INCLUDING PORTIONS HAVING DISTINCT POROSITIES, AND METHODS OF FORMING SAME

(71) Applicant: General Electric Company, Schenectady, NY (US)

(72) Inventors: Felix Martin Gerhard Roerig, Baden (CH); Thomas Etter, Muhen (CH); Brendon James Leary, Simpsonville, SC (US); Julius Andreas Schurb, Zurich (CH)

(21) Appl. No.: 15/680,734

(22) Filed: Aug. 18, 2017

(51) Int. Cl. B23K 26/342; B33Y 10/00; B33Y 30/00; B33Y 50/02; B33Y 80/00; B23K 26/082; B23K 26/08; B23K 26/144

(52) U.S. Cl. CPC B23K 26/342; B33Y 10/00; B33Y 30/00; B23K 26/144; B33Y 80/00; B23K 26/082; B23K 26/0884; B33Y 50/02

(57) ABSTRACT

Additive manufactured components including portions having distinct porosities, and systems/methods of forming components including portions having distinct porosities are disclosed. The components may include a first portion having a first porosity. The first portion may include a first exposure pattern of a plurality of scan vectors extending over the first portion. The first exposure pattern may define the first porosity of the first portion. The component may also include a second portion positioned adjacent the first portion. The second portion may include a second porosity greater than the first porosity of the first portion. Additionally, the second portion may include a second exposure pattern of a plurality of scan vectors extending over the second portion. The second exposure pattern may be distinct from the first exposure pattern of the first portion, and may define the second porosity of the second portion.

### BACKGROUND OF THE INVENTION

The disclosure relates generally to additive manufactured components, and more particularly, to additive manufactured components including portions having distinct porosities, and methods of forming components including portions having distinct porosities.

Components or parts for various machines and mechanical systems may be built using additive manufacturing systems. Additive manufacturing systems may build such components by continuously layering powder material in predetermined areas and performing a material transformation process, such as sintering or melting, on the powder material. The material transformation process may alter the physical state of the powder material from a granular composition to a solid material to build the component. The components built using the additive manufacturing systems have nearly identical physical attributes as conventional components typically made by performing machining processes (e.g., material removal processes) on stock material. However, because of the advantageous process, the components formed using additive manufacturing may include unique features and/or complex geometries that are difficult or impossible to obtain and/or build using conventional machining processes.

However, the capability of being able to easily form unique features and/or complex geometries results in new and/or additional manufacturing difficulties or issues. Specifically, the entire component formed using additive manufacturing may experience high tensile residual stress during the build process and/or during post-build process (e.g., machining, surface treatment, heat treatment, and the like). Additionally, unique features, such as channels formed through components, complex geometries, such as intricate curvatures in components, and/or thin walled sections, such as a section of the component formed between a channel and an exterior surface, may increase the high tensile residual stresses in specific portions of the component during the build process and/or during post-build processes. For example, during a shot peening process or a recrystallization process, the unique features and/or complex geometries formed in the component, and the exposed surface of the component surrounding the unique features and/or complex geometries, may increase the high tensile residual stress experienced by the component. The experienced high tensile residual stress may exceed the strength of the material used to form the component, and as a result, defects may be formed in the component. That is, defects (e.g., cracks, material deformation, material degradation, etc.) may form in the component during post-processing as a result of the high tensile residual stress experienced by the unique features and/or complex geometries, and surface of the component surrounding the unique features and/or complex geometries. Defects formed in the component can ultimately reduce the operational performance and/or the operational-life of the component, require undesirable maintenance, and/or necessitate complete component replacement.

### BRIEF DESCRIPTION OF THE INVENTION

A first aspect of the disclosure provides an additive manufactured component, including: a first portion having a first porosity, the first portion including: a first exposure pattern of a plurality of scan vectors extending over the first portion, the first exposure pattern defining the first porosity of the first portion; and a second portion positioned adjacent the first portion, the second portion having a second porosity greater than the first porosity of the first portion, and including: a second exposure pattern of a plurality of scan vectors extending over the second portion, the second exposure pattern, distinct from the first exposure pattern of the first portion, defining the second porosity of the second portion.

A second aspect of the disclosure provides an additive manufacturing system, including: at least one irradiation device emitting an irradiation beam to melt a raw material to form a component including: a first portion having a first porosity; and a second portion formed adjacent the first portion, the second portion having a second porosity greater than the first porosity; and at least one computing device operably connected to the at least one irradiation device, the at least one computing device configured to form the component using the at least one irradiation device by performing processes including: moving the irradiation beam of the at least one irradiation device in a first exposure pattern of a plurality of scan vectors to melt the raw material of the first portion of the component, the first exposure pattern defining the first porosity of the first portion; and moving the irradiation beam of the at least one irradiation device in a second exposure pattern of a plurality of scan vectors to melt the raw material of the second portion of the component, the second exposure pattern, distinct from the first exposure pattern of the first portion, defining the second porosity of the second portion.

A third aspect of the disclosure provides a method of forming a component using at least one irradiation device of an additive manufacturing system. The method including: moving an irradiation beam of the at least one irradiation device in a first exposure pattern of a plurality of scan vectors to melt a raw material to form a first portion of the component, the first exposure pattern defining a first porosity of the first portion; and moving the irradiation beam of the at least one irradiation device in a second exposure pattern of a plurality of scan vectors to melt the raw material of a second portion of the component, distinct from the first portion, wherein the second exposure pattern is distinct from the first exposure pattern of the first portion, and defines a second porosity of the second portion that is greater than the first porosity of the first portion.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a block diagram of an additive manufacturing system and process including a non-transitory computer readable storage medium storing code representative of a component according to embodiments of the disclosure.

FIG. 2 shows a top, cross-sectional view of a component including various portions having distinct porosities, according to embodiments of the disclosure.

FIGS. 3-12 shows a top, cross-sectional view of a part of a component including a first portion having a first porosity and a second portion having a second porosity, according to various embodiments of the disclosure. FIGS. 3-12 also includes various inserts showing a magnified view of the exposure pattern of two consecutive layers of the first portion and the second portion, respectively, according to various embodiments of the disclosure.

FIG. 13 shows a top, cross-sectional view of a component including a first portion having a first porosity and a second portion, including manufactured pores, having a second porosity, according to additional embodiments of the disclosure. FIG. 13 also includes various inserts showing a magnified view of the exposure pattern of two consecutive layers of the first portion and the second portion, respectively, according to various embodiments of the disclosure.

FIG. 14 shows a flow chart of an example process for forming an additive manufactured component with various portions having distinct porosities, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

The following disclosure relates generally to additive manufactured components, and more particularly, to additive manufactured components including portions having distinct porosities, and methods of forming components including portions having distinct porosities.

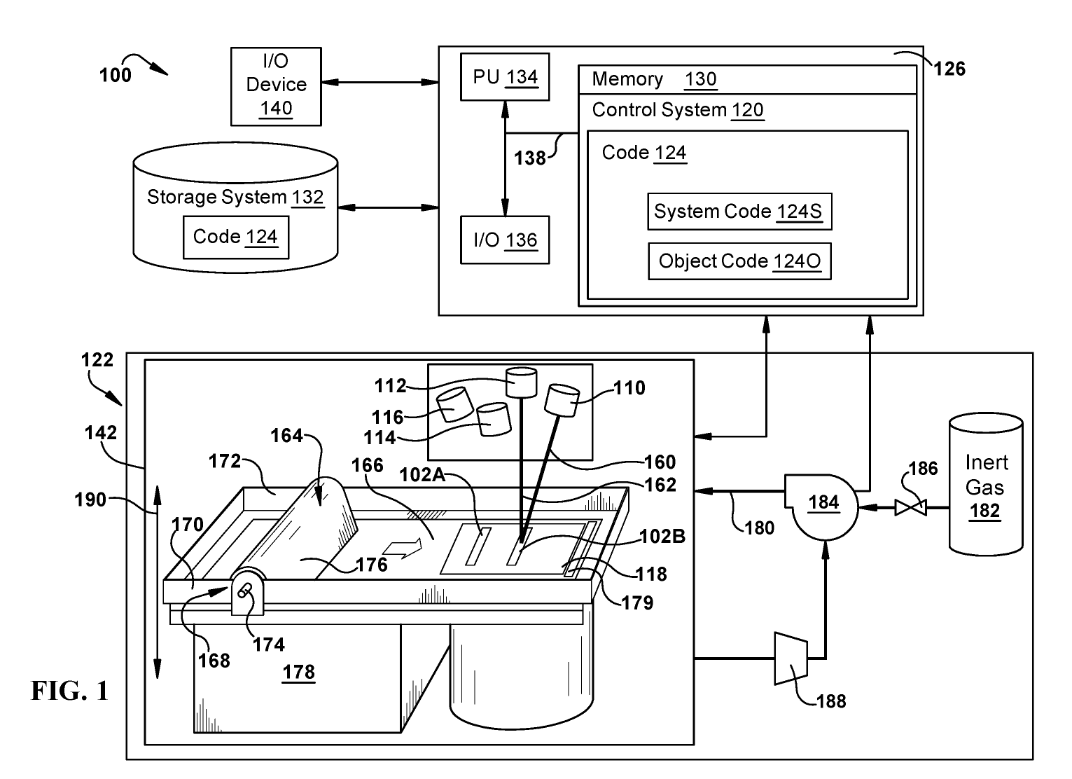

These and other embodiments are discussed below with reference to FIGS. 1-10. However, those skilled in the art will readily appreciate that the detailed description given herein with respect to these Figures is for explanatory purposes only and should not be construed as limiting.

FIG. 1 shows a schematic/block view of an illustrative computerized metal powder additive manufacturing system 100 (hereinafter ‘AM system 100’) for generating a component(s) 102, which may include one large component or multiple components, e.g., two components 102A, 102B as shown, of which only a single layer is shown. The teachings of the disclosures will be described relative to building component(s) 102 using multiple irradiation devices and/or distinct irradiation devices, e.g., four lasers 110, 112, 114, 116, but it is emphasized and will be readily recognized that the teachings of the disclosure are equally applicable to build multiple component(s) 102 using any number of irradiation devices, i.e., one or more. In this example, AM system 100 is arranged for direct metal laser melting (DMLM). It is understood that the general teachings of the disclosure are equally applicable to other forms of metal powder additive manufacturing such as but not limited to direct metal laser sintering (DMLS), selective laser sintering (SLS), Selective Laser Melting (SLM), electron beam melting (EBM), and perhaps other forms of additive manufacturing. Component(s) 102 are illustrated as rectangular elements; however, it is understood that the additive manufacturing process can be readily adapted to manufacture any shaped component, a large variety of components and a large number of components on a build platform 118.

AM system 100 generally includes a metal powder additive manufacturing control system 120 (“control system”) and an AM printer 122. As will be described, control system 120 executes component code 1240 to generate component(s) 102 using multiple irradiation devices 110, 112, 114, 116. In the example shown, four irradiation devices may include four lasers. However, the teachings of the disclosures are applicable to any irradiation device, e.g., an electron beam, laser, etc. Control system 120 is shown implemented on computer 126 as computer program code. To this extent, computer 126 is shown including a memory 130 and/or storage system 132, a processor unit (PU) 134, an input/output (110) interface 136, and a bus 138. Further, computer 126 is shown in communication with an external 110 device/resource 140 and storage system 132. In general, processor unit (PU) 134 executes computer program code 124 that is stored in memory 130 and/or storage system 132. While executing computer program code 124, processor unit (PU) 134 can read and/or write data to/from memory 130, storage system 132, 110 device 140 and/or AM printer 122. Bus 138 provides a communication link between each of the components in computer 126, and 110 device 140 can comprise any device that enables a user to interact with computer 126 (e.g., keyboard, pointing device, display, etc.). Computer 126 is only representative of various possible combinations of hardware and software. For example, processor unit (PU) 134 may comprise a single processing unit, or be distributed across one or more processing units in one or more locations, e.g., on a client and server. Similarly, memory 130 and/or storage system 132 may reside at one or more physical locations. Memory 130 and/or storage system 132 can comprise any combination of various types of non-transitory computer readable storage medium including magnetic media, optical media, random access memory (RAM), read only memory (ROM), etc. Computer 126 can comprise any type of computing device such as an industrial controller, a network server, a desktop computer, a laptop, a handheld device, etc.

As noted, AM system 100 and, in particular control system 120, executes program code 124 to generate component(s) 102. Program code 124 can include, inter alia, a set of computer-executable instructions (herein referred to as ‘system code 124S’) for operating AM printer 122 or other system parts, and a set of computer-executable instructions (herein referred to as ‘component code 1240’) defining component(s) 102 to be physically generated by AM printer 122. As described herein, additive manufacturing processes begin with a non-transitory computer readable storage medium (e.g., memory 130, storage system 132, etc.) storing program code 124. System code 124S for operating AM printer 122 may include any now known or later developed software code capable of operating AM printer 122.

Component code 1240 defining component(s) 102 may include a precisely defined 3D model of a component and can be generated from any of a large variety of well-known computer aided design (CAD) software systems such as AutoCAD®, TurboCAD®, DesignCAD 3D Max, etc. In this regard, component code 1240 can include any now known or later developed file format. Furthermore, component code 1240 representative of component(s) 102 may be translated between different formats. For example, component code 1240 may include Standard Tessellation Language (STL) files which was created for stereolithography CAD systems, or an additive manufacturing file (AMF), which is an international standard that is an extensible markup-language (XML) based format designed to allow any CAD software to describe the shape and composition of any three-dimensional component to be fabricated on any AM printer. Component code 1240 representative of component(s) 102 may also be converted into a set of data signals and transmitted, received as a set of data signals and converted to code, stored, etc., as necessary. In any event, component code 1240 may be an input to AM system 100 and may come from a part designer, an intellectual property (IP) provider, a design company, the operator or owner of AM system 100, or from other sources. In any event, control system 120 executes system code 124S and component code 1240, dividing component(s) 102 into a series of thin slices that assembles using AM printer 122 in successive layers of material.

AM printer 122 may include a processing chamber 142 that is sealed to provide a controlled atmosphere for component(s) 102 printing, e.g., a set pressure and temperature for lasers, or a vacuum for electron beam melting. A build platform 118, upon which component(s) 102 is/are built, is positioned within processing chamber 142. A number of irradiation devices 110, 112, 114, 116 are configured to melt layers of metal powder on build platform 118 to generate component(s) 102. While four irradiation devices 110, 112, 114, 116 will be described herein, it is emphasized that the teachings of the disclosure are applicable to a system employing any number of sources, e.g., 1, 2, 3, or 5 or more.

Returning to FIG. 1, an applicator 164 may create a thin layer of raw material 166 spread out as the blank canvas from which each successive slice of the final component will be created. Applicator 164 may move under control of a linear transport system 168. Linear transport system 168 may include any now known or later developed arrangement for moving applicator 164. In one embodiment, linear transport system 168 may include a pair of opposing rails 170, 172 extending on opposing sides of build platform 118, and a linear actuator 174 such as an electric motor coupled to applicator 164 for moving it along rails 170, 172. Linear actuator 174 is controlled by control system 120 to move applicator 164. Other forms of linear transport systems may also be employed. Applicator 164 take a variety of forms. In one embodiment, applicator 164 may include a member 176 configured to move along opposing rails 170, 172, and an actuator element (not shown in FIG. 1) in the form of a tip, blade or brush configured to spread metal powder evenly over build platform 118, i.e., build platform 118 or a previously formed layer of component(s) 102, to create a layer of raw material. The actuator element may be coupled to member 176 using a holder (not shown) in any number of ways. The process may use different raw materials in the form of metal powder. Raw materials may be provided to applicator 164 in a number of ways. In one embodiment, shown in FIG. 1, a stock of raw material may be held in a raw material source 178 in the form of a chamber accessible by applicator 164. In other arrangements, raw material may be delivered through applicator 164, e.g., through member 176 in front of its applicator element and over build platform 118. In any event, an overflow chamber 179 may be provided on a far side of applicator 164 to capture any overflow of raw material not layered on build platform 118. In FIG. 1, only one applicator 164 is shown. In some embodiments, applicator 164 may be among a plurality of applicators in which applicator 164 is an active applicator and other replacement applicators (not shown) are stored for use with linear transport system 168. Used applicators (not shown) may also be stored after they are no longer usable.

In one embodiment, component(s) 102 may be made of a metal which may include a pure metal or an alloy. In one example, the metal may include practically any non-reactive metal powder, i.e., non-explosive or non-conductive powder, such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), or a nickel-chromium-cobalt-molybdenum alloy (NiCrCoMo) (e.g., Haynes 282 available from Haynes International, Inc.), etc. In another example, the metal may include practically any metal such as but not limited to: tool steel (e.g., H13), titanium alloy (e.g., Ti₆Al₄V), stainless steel (e.g., 316L) cobalt-chrome alloy (e.g., CoCrMo), and aluminum alloy (e.g., AlSi₁₀Mg). In another example, the metal may include practically any reactive metal such as but not limited to those known under their brand names: IN738LC, Rene 108, FSX 414, X-40, X-45, MAR-M509, MAR-M302 or Merl 72/Polymet 972.

The atmosphere within processing chamber 142 is controlled for the particular type of irradiation device being used. For example, for lasers, processing chamber 142 may be filled with an inert gas such as argon or nitrogen and controlled to minimize or eliminate oxygen. Here, control system 120 is configured to control a flow of an inert gas mixture 180 within processing chamber 142 from a source of inert gas 182. In this case, control system 120 may control a pump 184, and/or a flow valve system 186 for inert gas to control the content of gas mixture 180. Flow valve system 186 may include one or more computer controllable valves, flow sensors, temperature sensors, pressure sensors, etc., capable of precisely controlling flow of the particular gas. Pump 184 may be provided with or without valve system 186. Where pump 184 is omitted, inert gas may simply enter a conduit or manifold prior to introduction to processing chamber 142. Source of inert gas 182 may take the form of any conventional source for the material contained therein, e.g. a tank, reservoir or other source. Any sensors (not shown) required to measure gas mixture 180 may be provided. Gas mixture 180 may be filtered using a filter 188 in a conventional manner. Alternatively, for electron beams, processing chamber 142 may be controlled to maintain a vacuum. Here, control system 120 may control a pump 184 to maintain the vacuum, and flow valve system 186, source of inert gas 182 and/or filter 188 may be omitted. Any sensors (not shown) necessary to maintain the vacuum may be employed.

A vertical adjustment system 190 may be provided to vertically adjust a position of various parts of AM printer 122 to accommodate the addition of each new layer, e.g., a build platform 118 may lower and/or chamber 142 and/or applicator 164 may rise after each layer. Vertical adjustment system 190 may include any now known or later developed linear actuators to provide such adjustment that are under the control of control system 120.

In operation, build platform 118 with metal powder thereon is provided within processing chamber 142, and control system 120 controls the atmosphere within processing chamber 142. Control system 120 also controls AM printer 122, and in particular, applicator 164 (e.g., linear actuator 174) and irradiation device(s) 110, 112, 114, 116 to sequentially melt layers of metal powder on build platform 118 to generate component(s) 102 according to embodiments of the disclosure. As noted, various parts of AM printer 122 may vertically move via vertical adjustment system 190 to accommodate the addition of each new layer, e.g., a build platform 118 may lower and/or chamber 142 and/or applicator 164 may rise after each layer.

In the non-limiting example, each irradiation device 110, 112, 114, 116 may generate an irradiation beam (two shown, 160, 162, in FIG. 1), respectively, that fuses particles for each slice, as defined by object code 1240. Each irradiation device 110, 112, 114, 116 is calibrated in any now known or later developed manner. That is, each irradiation device 110, 112, 114, 116 has had its laser or electron beam's anticipated position relative to build platform 118 correlated with its actual position in order to provide an individual position correction (not shown) to ensure its individual accuracy. In one embodiment, each of plurality irradiation devices 110, 112, 114, 116 may create irradiation beams, e.g., 160, 162 (FIG. 1), having the same cross-sectional dimensions (e.g., shape and size in operation), power and scan speed.

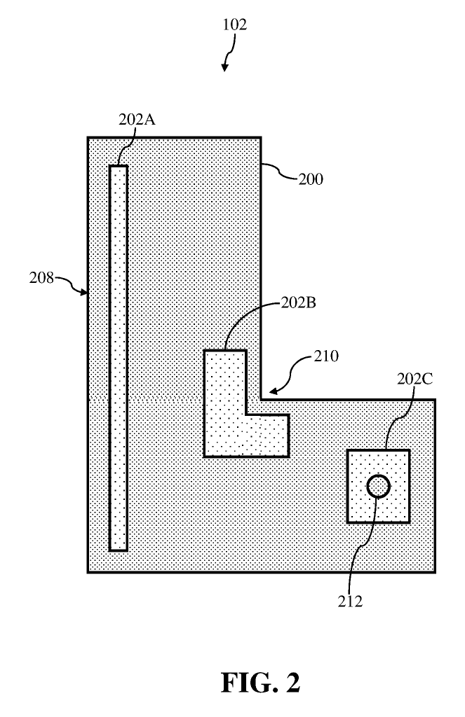

FIG. 2 shows a top, cross-sectional view of a non-limiting example of component 102 shown in FIG. 1 and discussed as being formed using AM system 100. Specifically, FIG. 2 shows a top, cross-sectional view of component 102 where a top surface and/or a top portion of component 102 may be removed to expose an inner portion or inner layer of component 102. Component 102 may be considered an “intermediately” formed component and/or a component that may be in an intermediate stage of building and/or processing. As such, and as discussed herein, component 102 may undergo additional post-build processes after being formed by AM system 100, as discussed herein with respect to FIG. 1. The post-build processes may be performed before the final configuration of component 102 may be utilized for its intended purpose.

As shown in FIG. 2, component 102 may include a plurality of distinct portions. Specifically, AM system 100 may form component 102 to include a first portion 200, and a second portion(s) 202A, 202B, 202C. In the non-limiting example shown in FIG. 2, first portion 200 may substantially surround second portions 202A, 202B, 202C in component 102. Additionally in the non-limiting example, component 102 may include three distinct, second portions 202A, 202B, 202C. It is understood that the number of second portions 202A, 202B, 202C formed and/or included in component 102, as shown in the figures, may be merely illustrative. As such, component 102 may include more or less second portions 202A, 202B, 202C than the number depicted and discussed herein.

First portion 200 and second portion(s) 202A, 202B, 202C may be formed integrally by AM system 100 (see, FIG. 1) to form component 102. Specifically, first portion 200, and second portion(s) 202A, 202B, 202C may not be separate or distinct components or parts, but rather are integrally and/or indivisibly formed by AM system 100 to create component 102. However, build and/or material characteristics of first portion 200 and second portion 202A, 202B, 202C of component 102 may be distinct. That is, and as discussed herein, second portion 202A, 202B, 202C of component 102 may include a distinct porosity from the porosity of first portion 200.

Second portions 202A, 202B, 202C may be formed in high tensile residual stress areas or sections of component 102, or directly adjacent to high tensile residual stress areas or section of component 102. More specifically, AM system 100 (see, FIG. 1) may form second portions 202A, 202B, 202C, including a distinct build and/or material characteristics (e.g., porosity) from first portion 200, in areas or sections of component 102 that may experience high tensile residual stress during the building process and/or when performing post-build process(es) on component 102. As a result of the distinct build and/or material characteristics of second portions 202A, 202B, 202C, and as discussed herein, second portions 202A, 202B, 202C may substantially minimize and/or eliminate the experience of tensile stress in the areas of component 102 including second portions 202A, 202B, 202C. This may ultimately reduce the risk of defects forming in component 102 during the build process and/or when performing the post-build process(es) on component 102.

In the non-limiting example shown in FIG. 2, all second portions 202A, 202B, 202C may be formed in component 102, which may experience high tensile residual stress during the build and/or post-build process(es). Additionally, the non-limiting examples of second portions 202A, 202B, 202C shown in FIG. 2 may be formed in areas or sections of component 102 that may experience high tensile residual stress, and/or greater tensile residual stress than distinct portions of component 102, as a result of adjacent or surrounding geometries and/or features of component 102. For example, component 102 may experience high or increased tensile residual stress at and/or directly adjacent a sidewall 208 of component 102 because of sidewall's 208 length (L). As such, second portion 202A may be formed adjacent sidewall 208, and may extend through component 102 substantially along the length (L) of sidewall 208. In another non-limiting example, second portion 202B may be formed adjacent a bend or elbow 210 (hereafter, “elbow 210”) of component 102 that may experience high tensile residual stress during the build and/or post-build process(es). As shown in FIG. 2, second portion 202B may include a substantially matching and/or corresponding geometry to minimize and/or eliminate the experience of tensile stress in the area of component 102 including second portion 202B. In an additional non-limiting example, second portion 202C may be formed adjacent and/or may substantially surround a feature 212 formed in component 102. In the non-limiting example, feature 212 may be a recess or a channel formed through component 102. By surrounding feature 212, second portion 202C may substantially minimize and/or eliminate the tensile stress experienced by feature 212 of component 102, and the area immediately surrounding feature 212, respectively.

In a non-limiting example, second portions 202A, 202B, 202C may be formed entirely through component 102 (e.g., entire height of component 102), and/or may extend within component 102 between a top surface (not shown) and a bottom surface (not shown) of component 102. In another non-limiting example, second portions 202A, 202B, 202C may extend only partially through and/or may be formed only partially through the entire height of component 102. In this non-limiting example, second portions 202A, 202B, 202C may extend partially through component 102 between top surface and bottom surface of component 102. Additionally, first portion 200 may substantially surround second portions 202A, 202B, 202C only extending partially through component 102. The height and/or depth in which second portions 202A, 202B, 202C extends through component 102 may be dependent, at least in part, on the tensile stress experienced by component 102 during the building process and/or when performing post-build process(es) on component 102, as discussed herein.

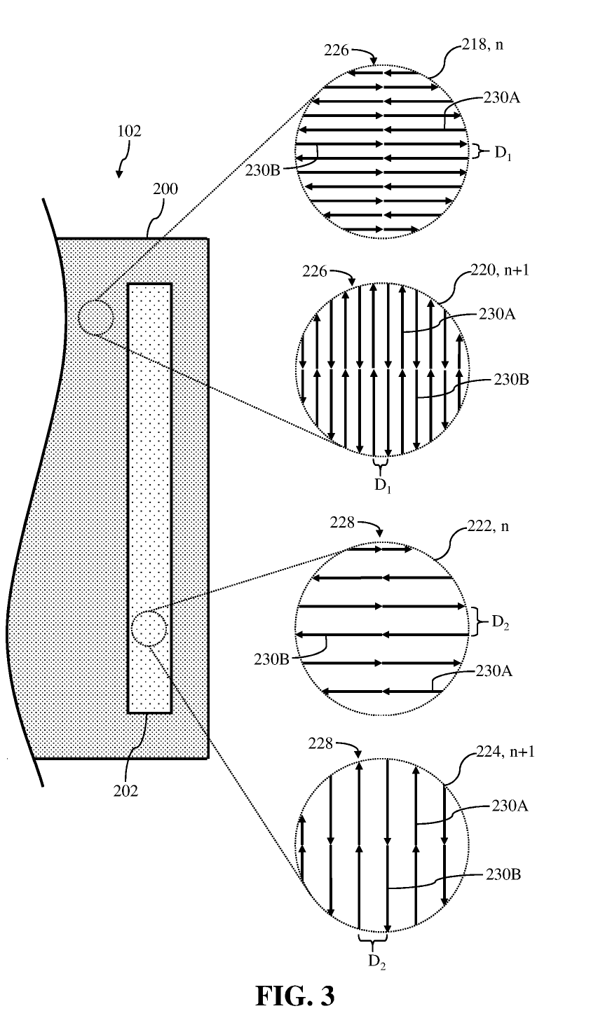

FIG. 3 shows another non-limiting example of component 102 formed by AM system 100. Specifically, FIG. 3 shows a top, cross-sectional view of a part of component 102 including first portion 200 and second portion 202. Additionally, and as discussed herein, FIG. 3 shows various inserts showing magnified views of first portion 200 and second portion 202 of component 102. It is understood that similarly numbered and/or named components may function in a substantially similar fashion. Redundant explanation of these components has been omitted for clarity.

The various inserts 218, 220, 222, 224 of FIG. 3 may depict magnified views of exposure patterns 226, 228 for first portion 200 and second portion 202 of component 102, respectively. Specifically, the various inserts 218, 220, 222, 224 may depict or show magnified views of exposure patterns 226, 228 formed in a first layer (n), and a subsequent layer (n+1) for each of first portion 200 and second portion 202 of component 102. The subsequent layer (n+1) may be layer of component 102 formed above, on top of, and/or over the first layer (n) of component 102. In the non-limiting example shown in FIG. 3, and as discussed in detail herein, insert 218 may depict first exposure pattern 226 for a first layer (n) of first portion 200, and insert 220 may depict first exposure pattern 226 for a subsequent layer (n+1) of first portion 200. Additionally, and as discussed herein in detail, insert 222 may depict second exposure pattern 228 for a first layer (n) of second portion 202, and insert 224 may depict second exposure pattern 228 for a subsequent layer (n+1) of second portion 202.

Exposure patterns 226, 228 of first portion 200 and second portion 202 may represent a melting pattern for irradiation device(s) 110, 112, 114, 116 of AM system 100 when forming and/or melting layers of raw material 166 (see, FIG. 1). That is, and as discussed herein with respect to FIG. 1, exposure patterns 226, 228 may be melting pattern and/or a movement path for irradiation device(s) 110, 112, 114, 116 and/or irradiation beam(s) 160, 162 when irradiation device(s) 110, 112, 114, 116 performs the process of melting raw material 166 to form first portion 200 and second portion 202 of component 102.

As shown in the various inserts 218, 220, 222, 224 of FIG. 3, exposure patterns 226, 228 may include at least one scan vector 230A, 230B. Specifically, exposure patterns 226, 228 of first portion 200 and second portion 202, respectively, may include and/or be formed as at least one or a plurality of scan vectors 230A, 230B. As discussed herein, first exposure pattern 226 may include the plurality of scan vectors 230A, 230B extending over and/or forming first portion 200, and first exposure pattern 228 may include the plurality of scan vectors 230A, 230B extending over and/or forming second portion 202. Scan vectors 230A, 230B of exposure patterns 226, 228 may represent a stripe, line, and/or path of melted, raw material 166 formed by irradiation device(s) 110, 112, 114, 116 of AM system 100 when forming component 102. Additionally, in the non-limiting examples, the depicted arrows included in scan vectors 230A, 230B may indicate and/or represent a direction of movement of irradiation device(s) 110, 112, 114, 116, and/or irradiation beam 160, 162 when following and/or moving in accordance with exposure patterns 226, 228, as discussed herein. It is understood that two substantially abutting and/or touching arrows representing an individual scan vector 230A, 230B for exposure patterns 226, 228 may indicate that the individual scan vector 230A, 230B is a continuous, non-segmented scan vector formed by continuously moving irradiation device(s) 110, 112, 114, 116 in the indicated direction, and continuously exposing raw material 166 to irradiation beam 160, 162.

As shown in FIG. 3, insert 218 may depict first exposure pattern 226 for a first layer (n) of first portion 200, and insert 220 may depict first exposure pattern 226 for a subsequent layer (n+1) of first portion 200. In the non-limiting example, both the first layer (n) and the subsequent layer (n+1) of first portion 200 may include and/or be formed using first exposure pattern 226. However, in comparing insert 218 and insert 220, first exposure pattern 226 in subsequent layer (n+1) may be substantially positioned, angled, rotated, and/or include an (angular) orientation that is distinct from the (angular) orientation of first exposure pattern 226 in the first layer (n). That is, the plurality of scan vectors 230A, 230B of first exposure pattern 226 in subsequent layer (n+1) may be substantially angled, rotated (e.g., rotated counterclockwise approximately 90 degrees (90°)), and/or include an (angular) orientation that is distinct from the (angular) orientation of the plurality of scan vectors 230A, 230B of first exposure pattern 226 in the first layer (n).

Additionally as shown in inserts 218, 220 of FIG. 3, each the plurality of scan vectors 230A, 230B of first exposure pattern 226 may be positioned, angled, extend, and/or include an (angular) orientation that is substantially similar or identical to distinct scan vectors 230A, 230B. Specifically, the plurality of scan vectors 230A, 230B of first exposure pattern 226 may be positioned, oriented, and/or formed to be substantially non-intersecting and/or parallel to one another. That is, the plurality of scan vectors 230A, 230B may be formed to be non-intersecting with one another, such that no scan vectors 230A, 230B of first exposure pattern 226 may cross, overlap, interfere and/or encroach on a path of a distinct scan vector 230A, 230B.

In a non-limiting example shown in inserts 218, 220 of FIG. 3, first exposure pattern 226 of first portion 200 may include an alternating directional pattern for the plurality of scan vectors 230A, 230B. More specifically, the plurality of scan vectors 230A, 230B of first exposure pattern 226 may be formed by alternating the direction of movement of irradiation device(s) 110, 112, 114, 116, and/or irradiation beam 160, 162 when following and/or moving in accordance with first exposure pattern 226. For example, and with reference to insert 218, scan vector 230A of first exposure pattern 226 may be formed by moving irradiation device(s) 110, 112, 114, 116, and/or irradiation beam 160, 162 in a first direction (e.g., right-to-left). Additionally, scan vector 230B of first exposure pattern 226 may be formed by moving irradiation device(s) 110, 112, 114, 116, and/or irradiation beam 160, 162 in a second direction (e.g., left-to-right), distinct from the first.

Each of the plurality of scan vectors 230A, 230B of first exposure pattern 226 may include and/or may be formed using a build strategy parameter. Specifically, irradiation device(s) 110, 112, 114, 116, and/or irradiation beam 160, 162 of AM system 100 forming the plurality of scan vectors 230A, 230B of first exposure pattern 226 may form the plurality of scan vectors 230A, 230B using a first build strategy parameter. The build strategy parameter may control one or more aspect(s) of how a particular printing device operates. In this example, build strategy parameters may include, but are not limited to: processing chamber temperature, pressure, etc.; irradiation beam 160, 162 width, speed, power; scan vector length and start/stop positions; irradiation device assignments; scan vector end gap spacing and positioning; and stitching region position, size and shape/path. Additionally, build strategy parameters may also include, and as discussed herein, a distance and/or spacing separating each scan vector of the plurality of scan vectors 230A, 230B for the respective exposure patterns 226, 228.

Also shown in inserts 218, 220 of FIG. 3, the plurality of scan vectors 230A, 230B of first exposure pattern 226 may be spaced evenly from one another. Specifically, each of the plurality of scan vectors 230A, 230B for first exposure pattern 226 forming first portion 200 may be separated from one another by a first distance (D₁). The first distance (D₁) separating each of the plurality of scan vectors 230A, 230B may be maintained in each layer (e.g., first layer (n), subsequent layer (n+1)) of first portion 200. That is, and comparing insert 218 and insert 220, each of the plurality of scan vectors 230A, 230B of first exposure pattern 226 forming the first layer (n) and the subsequent layer (n+1) may be separated by the first distance (D₁).

As discussed herein, first portion 200 may include a build and/or material characteristic that is distinct from a build and/or material characteristics of second portion 202 of component 102. For example, first portion 200 may include a first porosity that is distinct from, and more specifically less than, a second porosity of second portion 202 discussed herein. The porosity of first portion 200 may be defined by first exposure pattern 226. More specifically, first exposure pattern 226 of the plurality of scan vectors 230A, 230B, the direction of movement (e.g., first direction, second direction) of irradiation device(s) 110, 112, 114, 116, and/or irradiation beam 160, 162 for forming the plurality of scan vectors 230A, 230B of first exposure pattern 226, and/or the first distance (D₁) separating each of the plurality of scan vectors 230A, 230B of first exposure pattern 226 may define, determine, and/or control the porosity of first portion 200 of component 102.

Also shown in FIG. 3, insert 222 may depict second exposure pattern 228 for the first layer (n) of second portion 202, and insert 224 may depict second exposure pattern 228 for the subsequent layer (n+1) of second portion 202. In the non-limiting example, both the first layer (n) and the subsequent layer (n+1) of second portion 202 may include and/or be formed using second exposure pattern 228. However, in comparing insert 222 and insert 224, and as similarly discussed herein with respect to insert 218 and insert 220, the plurality of scan vectors 230A, 230B of second exposure pattern 228 in subsequent layer (n+1) may be substantially angled, rotated (e.g., rotated counterclockwise approximately 90 degrees (90°)), and/or include an (angular) orientation that is distinct from the (angular) orientation of the plurality of scan vectors 230A, 230B of second exposure pattern 228 in the first layer (n).

Also as similarly discussed herein within respect to inserts 218, 220 of FIG. 3, each the plurality of scan vectors 230A, 230B of second exposure pattern 228 shown in inserts 222, 224 may be positioned, angled, extend, and/or include an (angular) orientation that is substantially similar or identical to a distinct scan vectors 230A, 230B. As a result, each the plurality of scan vectors 230A, 230B of second exposure pattern 228 may be formed to be substantially non-intersecting and/or parallel to one another, and may not crossover, overlap, interfere, and/or encroach on a path of a distinct scan vector 230A, 230B.

In a non-limiting example shown in inserts 222, 224 of FIG. 3, second exposure pattern 228 of second portion 202 may include an alternating directional pattern for the plurality of scan vectors 230A, 230B. More specifically, and similar to first exposure pattern 226, the plurality of scan vectors 230A, 230B of second exposure pattern 228 may be formed by alternating the direction of movement of irradiation device(s) 110, 112, 114, 116, and/or irradiation beam 160, 162 when following and/or moving in accordance with second exposure pattern 228. As shown in insert 222, scan vector 230A of second exposure pattern 228 may be formed by moving irradiation device(s) 110, 112, 114, 116, and/or irradiation beam 160, 162 in a first direction (e.g., right-to-left), and scan vector 230B of second exposure pattern 228 may be formed by moving irradiation device(s) 110, 112, 114, 116, and/or irradiation beam 160, 162 in a second direction (e.g., left-to-right), distinct from the first direction.

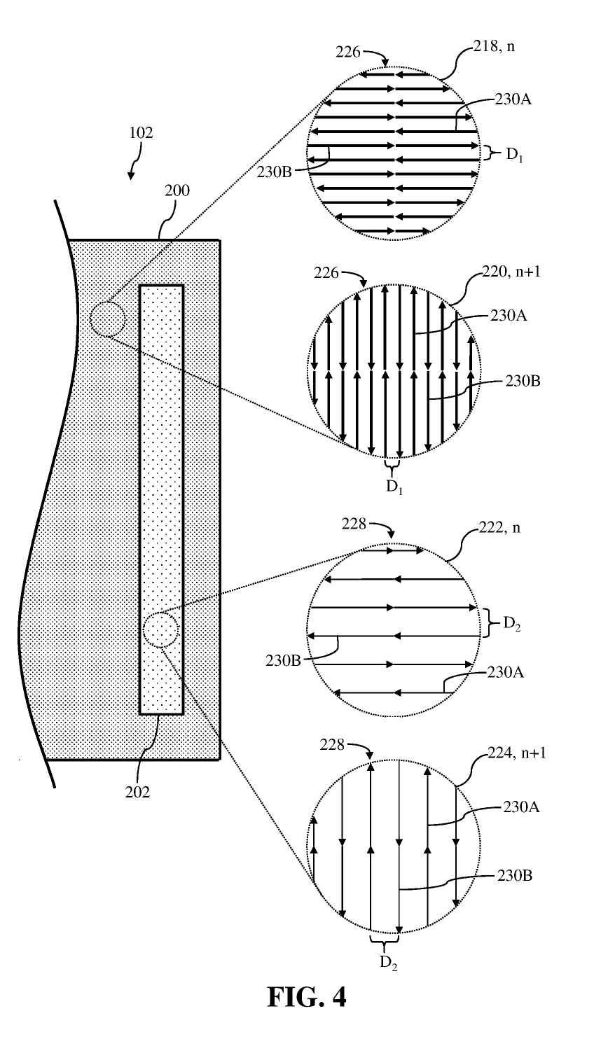

Each of the plurality of scan vectors 230A, 230B of second exposure pattern 228 may include and/or may be formed using a build strategy parameter. Specifically, and similar to first exposure pattern 226, irradiation device(s) 110, 112, 114, 116, and/or irradiation beam 160, 162 of AM system 100 forming the plurality of scan vectors 230A, 230B of second exposure pattern 228 may form the plurality of scan vectors 230A, 230B using a second build strategy parameter. In the non-limiting example shown in FIG. 3, the first build strategy parameter(s) of first exposure pattern 226 may be substantially similar and/or identical to the second build strategy parameter(s) of second exposure pattern 228. In other non-limiting examples discussed herein (see, FIG. 4), the first build strategy parameter(s) of first exposure pattern 226 may be substantially distinct from the second build strategy parameter(s) of second exposure pattern 228. The distinction in build strategy parameter(s) between first exposure pattern 226 and second exposure pattern 228 may further define the porosities in each portion (e.g., first portion 200, second portion 202) of component 102.

The plurality of scan vectors 230A, 230B of second exposure pattern 228 may be spaced evenly from one another. That is, and as substantially similar to first exposure pattern 226 discussed herein, each of the plurality of scan vectors 230A, 230B for second exposure pattern 228 forming second portion 202 may be evenly separated from one another. However distinct from first exposure pattern 226, each of the plurality of scan vectors 230A, 230B for second exposure pattern 228 may be separated from one another by a second distance (D₂). The second distance (D₂) separating each of the plurality of scan vectors 230A, 230B for second exposure pattern 228 may be substantially larger than the first distance (D₁) separating each of the plurality of scan vectors 230A, 230B for first exposure pattern 226.

As discussed herein, second portion 202 may include a second porosity that is distinct from, and more specifically greater than, the first porosity of first portion 200 of component 102. Similar to the first porosity of first portion 202, the second porosity of second portion 202 may be defined by second exposure pattern 228. More specifically, second exposure pattern 228 of the plurality of scan vectors 230A, 230B, the direction of movement (e.g., first direction, second direction) of irradiation device(s) 110, 112, 114, 116, and/or irradiation beam 160, 162 for forming the plurality of scan vectors 230A, 230B of second exposure pattern 228, and/or the second distance (D₂) separating each of the plurality of scan vectors 230A, 230B of second exposure pattern 228 may define, determine, and/or control the porosity of second portion 202 of component 102. In the non-limiting example shown in FIG. 3, the second porosity of second portion 202 may be substantially greater than the first porosity of the first portion 200 as a result of the second distance (D₂) separating the plurality of scan vectors 230A, 230B of second exposure pattern 228 being larger than first distance (D₁) separating the plurality of scan vectors 230A, 230B of first exposure pattern 226. In one non-limiting example, the second distance (D₂) separating the plurality of scan vectors 230A, 230B of second exposure pattern 228 may reduce the porosity of second portion 202 by reducing the overlap percentage of melt pools of material between adjacent scan vector 230A, 230B of second exposure pattern 228. That is, and with comparison to first portion 200 that may include melt pools of material for adjacent scan vector 230A, 230B that may overlap by approximately 25% to approximately 40%, second portion 202 may include melt pools of material for adjacent scan vector 230A, 230B that may overlap by approximately 5% to approximately 20%. Additionally, or conversely in another non-limiting example, the second distance (D₂) separating the plurality of scan vectors 230A, 230B of second exposure pattern 228 may reduce the porosity of second portion 202 by not completely transforming and/or melting all of raw material 166 forming second portion 202 during the component build process discussed herein with respect to AM system 100 and FIG. 1. As discussed herein, unmelted, raw material 166 of second portion 202 may be transformed during post-build processes performed on component 102 to ensure component 102 does not include any raw material 166 before being used.

As discussed herein, second portion 202 including second exposure 228 may be formed in areas of component 102 that may include high tensile residual stress during the build process and/or during post-build process(es). Because of the increased porosity in second portion 202, second portion 202 may substantially minimize and/or eliminate the experience of tensile stress in areas of component 102, which may ultimately reduce the risk of defects forming in component 102. Subsequent to forming component 102 including second portion 202, and prior to utilizing component 102 for its intended purpose, it may be desirable to substantially reduce the porosity of second portion 202, and/or form component 102 to include a uniform porosity (e.g., first porosity of first portion 200 is equal to second porosity of second portion 202). This may ensure component 102 operates as intended and/or reduces the risk of defect formed in second portion 202 during operation as a result of the larger, second porosity.

As such, the second porosity may include characteristics, properties, and/or parameters, as defined by second exposure pattern 228 (e.g., second distance (D₂) separating scan vectors 230A, 230B), that may be substantially altered during a post-build process (e.g., hot isostatic pressing) performed on component 102 to reduce the porosity of second portion 202. For example, and with reference to FIG. 3, after forming component 102 including second portion 202 with the increased, second porosity to reduce tensile residual stress during the build process and/or post-build process(es), a hot isostatic pressing process (e.g., additional or final post-build process) may be performed on component 102. The hot isostatic pressing process may substantially melt and/or transform the material/microstructure of component 102, and/or the material the material used to form second portion 202 of component 102. More specifically, the hot isostatic pressing process may substantially melt and/or transform raw material 166 formed between scan vectors 230A, 230B of second exposure pattern 228, and/or transform previously melted raw material 166 by AM system 100 when forming second portion 202. The transformation of the material (e.g., unmelted and/or previously melted) may reduce the porosity of second portion 202, and/or ensure second portion 202 includes a substantially equal porosity as first portion 200 of component 102 prior to using component 102 for its intended purpose.

FIGS. 4-12 show additional non-limiting examples of a part of component 102 including first portion 200 and second portion 202. Additionally, FIGS. 4-12 show various inserts showing magnified views of first portion 200 and second portion 202 of component 102. It is understood that similarly numbered and/or named components may function in a substantially similar fashion. Redundant explanation of these components has been omitted for clarity.

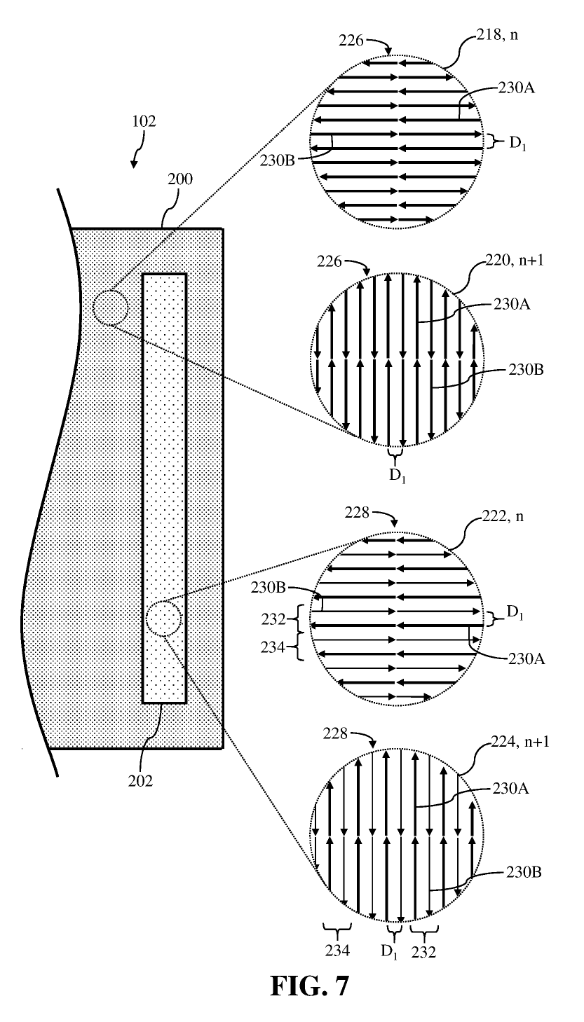

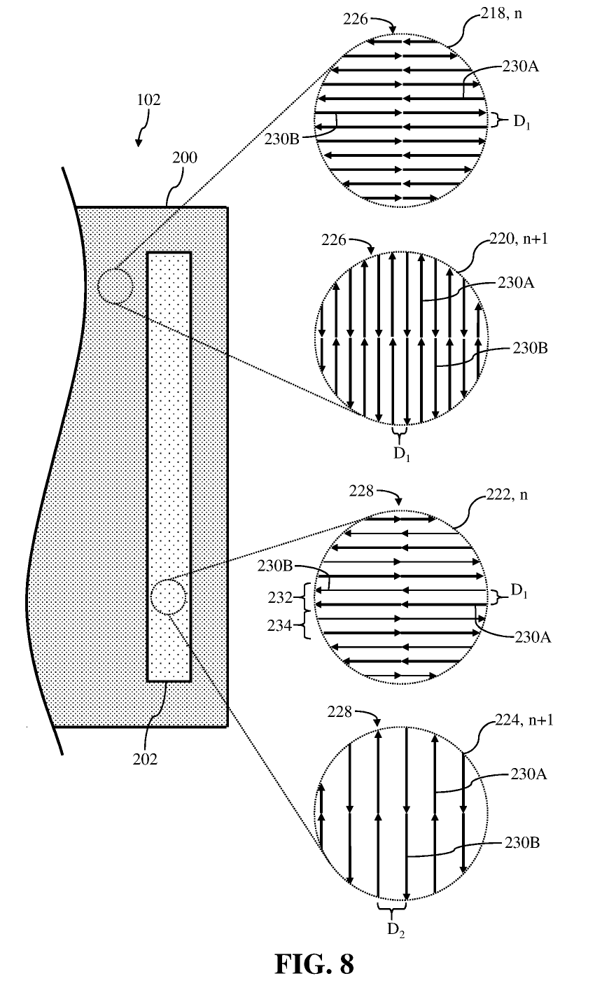

Second exposure pattern 228 forming second portion 202 shown in FIG. 4, and specifically inserts 222, 224, may be substantially similar to second exposure pattern 228 discussed herein with respect to FIG. 3. For example, second exposure pattern 228 shown in FIG. 4 may include a plurality of scan vectors 230A, 230B, alternating directional pattern for the plurality of scan vectors 230A, 230B, and the second distance (D₂) separating adjacent scan vectors 230A, 230B, substantially similar or identical to second exposure pattern 228 discussed herein with respect to FIG. 3. However, distinct from second exposure pattern 228 discussed herein with respect to FIG. 3, the build strategy parameter(s) of second exposure pattern 228 may be substantially distinct from the build strategy parameter(s) of first exposure pattern 226. More specifically, the second build strategy parameter(s) of second exposure pattern 228 may be substantially distinct and/or different from the first build strategy parameter(s) of first exposure pattern 226. For example, the irradiation beam 160, 162 width may be smaller, speed may be greater, and/or power may be less for the second build strategy parameter(s) of second exposure pattern 228, when compared to the irradiation beam 160, 162 width may be smaller, speed may be greater, and/or power may be less for the first build strategy parameter(s) of first exposure pattern 226. As a result, second portion 202 formed using second exposure pattern 228 may include second porosity greater than the first porosity of first portion 200. As shown in FIG. 4, and used in other non-limiting examples herein (e.g., FIGS. 7 and 8), the distinction in the build strategy parameter(s) between first exposure pattern 226 and second exposure pattern 228 may be indicated by the weight and/or thickness of the lines or arrows forming the plurality of scan vectors 230A, 230B.

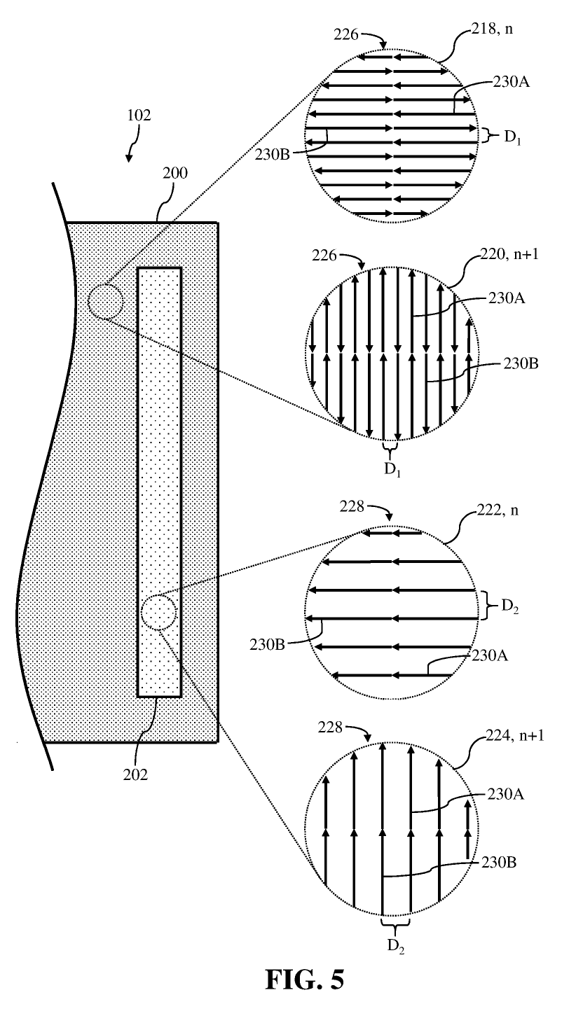

Second exposure pattern 228 forming second portion 202 shown in FIG. 5, and specifically inserts 222, 224, may also be substantially similar to second exposure pattern 228 discussed herein with respect to FIG. 3 (e.g., plurality of scan vectors 230A, 230B, second distance (D₂) separating adjacent scan vectors 230A, 230B, similar build strategy parameters, and the like). However, distinct from second exposure pattern 228 shown in FIG. 3, second exposure pattern 228 of FIG. 5 may not include an alternating directional pattern for the plurality of scan vectors 230A, 230B. Rather, the plurality of scan vectors 230A, 230B of second exposure pattern 228 may be formed by maintaining a single direction of movement of irradiation device(s) 110, 112, 114, 116, and/or irradiation beam 160, 162 when following and/or moving in accordance with second exposure pattern 228. For example, and with reference to insert 222 in FIG. 5, each of the plurality of scan vectors 230A, 230B of second exposure pattern 228 may be formed by moving irradiation device(s) 110, 112, 114, 116, and/or irradiation beam 160, 162 in the first direction (e.g., right-to-left shown in insert 222; bottom-to-top in insert 224).

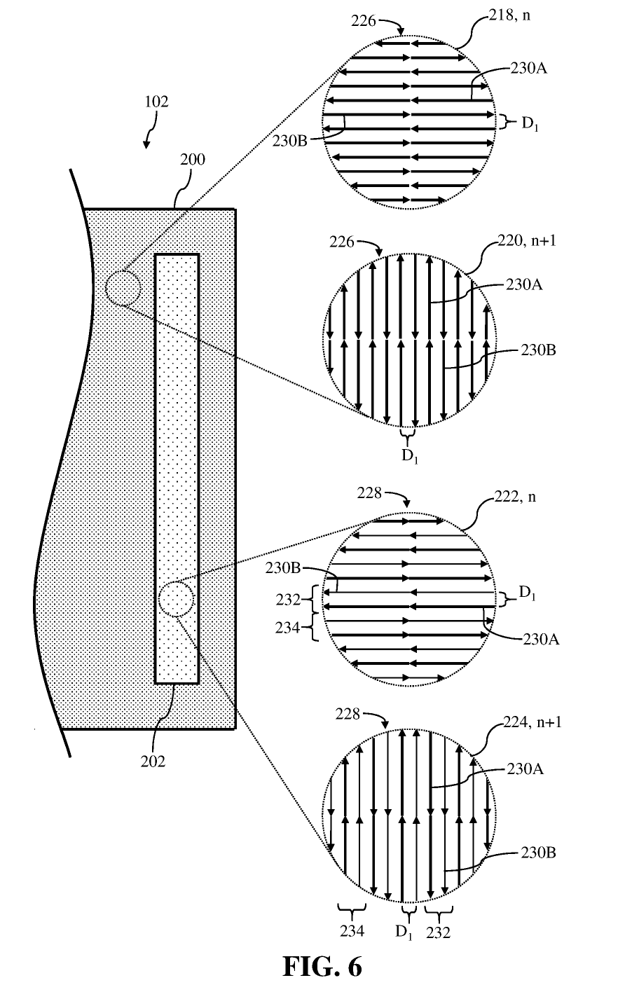

Turning to FIG. 6, another non-limiting example of second exposure pattern 228 of the plurality of scan vectors 230A, 230B forming second portion 202 is shown in inserts 222, 224. In the non-limiting example, the plurality of scan vectors 230A, 230B may include and/or be formed into a plurality of distinct groups 232, 234. Specifically, the plurality of scan vectors 230A, 230B of second exposure pattern 228 may include a plurality of distinct groups including a first group 232, and a second group 234. In the non-limiting example shown in FIG. 6, each of first group 232 and second group 234 may include two distinct scan vectors 230A, 230B. Additionally in the non-limiting example, scan vector 230A of first group 232 and second group 234 may include distinct build strategy parameters as the build strategy parameters of scan vector 230B. The build strategy parameters of scan vector 230B of first group 232 and second group 234 may be substantially similar to, or distinct from, the build strategy parameters for the plurality of scan vectors 230A, 230B of first exposure pattern 226 forming first portion 200. It is understood that the number of scan vectors 230A, 230B including in each of first group 232 and/or second group 234, as shown in the figures, may be merely illustrative. As such, each of first group 232 and/or or second group 234 may include more scan vectors 230A, 230B than the number depicted and discussed herein.

In a non-limiting example shown in inserts 222, 224 of FIG. 6, second exposure pattern 228 may include an alternating directional pattern for the plurality of groups 232, 234 of the plurality of scan vectors 230A, 230B. More specifically, second exposure pattern 228 may be formed by alternating the direction of movement of irradiation device(s) 110, 112, 114, 116, and/or irradiation beam 160, 162 when forming first group 232 and second group 234; each including scan vectors 230A, 230B. For example, and with reference to insert 222, first group 232 including two scan vectors 230A, 230B may be formed by moving irradiation device(s) 110, 112, 114, 116, and/or irradiation beam 160, 162 in a first direction (e.g., right-to-left). Additionally, second group 234 including two scan vectors 230A, 230B may be formed by moving irradiation device(s) 110, 112, 114, 116, and/or irradiation beam 160, 162 in a second direction (e.g., left-to-right), distinct from the first.

Also shown in inserts 222, 224 of FIG. 6, the plurality of scan vectors 230A, 230B of second exposure pattern 228 may be spaced evenly from one another. Specifically, each of the plurality of scan vectors 230A, 230B for second exposure pattern 228 forming second portion 202 may be separated from one another by a first distance (D₁). Additionally, scan vector 230A of first group 232 may be separated from scan vector 230B of second group 234 by the first distance (D₁). The first distance (D₁) separating each of the plurality of scan vectors 230A, 230B, and/or first group 232 and second group 234 of second exposure pattern 228 may be substantially equal to the first distance (D₁) separating each of the plurality of scan vectors 230A, 230B of first exposure pattern 226 (see, insert 218; FIG. 6).

FIG. 7 shows another non-limiting example of the plurality of scan vectors 230A, 230B of second exposure pattern 228 including first group 232 and second group 234, respectively. However, distinct from the non-limiting example shown in FIG. 6, second exposure pattern 228 may not include an alternating directional pattern for the plurality of groups 232, 234 of the plurality of scan vectors 230A, 230B. Rather, each group 232, 234 of the plurality of scan vectors 230A, 230B of second exposure pattern 228 may include an alternating direction pattern for the scan vectors 230A, 230B. For example, and with reference to insert 222, scan vector 230B of first group 232 and second group 234, respectively, may be formed by moving irradiation device(s) 110, 112, 114, 116, and/or irradiation beam 160, 162 in a first direction (e.g., right-to-left). Additionally, scan vector 230A of first group 232 and second group 234, respectively, may be formed by moving irradiation device(s) 110, 112, 114, 116, and/or irradiation beam 160, 162 in a second direction (e.g., left-to-right), distinct from the first.

FIG. 8 shows another non-limiting example for forming second portion 202 of component 102. Specifically, insert 222 of FIG. 8 shows second portion 202 including second exposure pattern 228 formed in the first layer (n). Second exposure pattern 228 shown in insert 222 may be substantially similar to second exposure pattern 228 shown and discussed herein with respect to FIG. 6. Additionally, insert 224 of FIG. 8 shows second portion 202 including a third exposure pattern 236 formed in the subsequent layer (n+1). That is, second portion 202 may be formed using a plurality of distinct exposure patterns 228, 236, where the exposure patterns 228, 236 forming second portion 202 vary between layers (e.g., first layer (n), subsequent layer (n+1)). In the non-limiting example shown in FIG. 8, third exposure pattern 236 may be substantially similar to second exposure pattern 228 shown and discussed herein with respect to FIG. 3 (see, insert 224; FIG. 3).

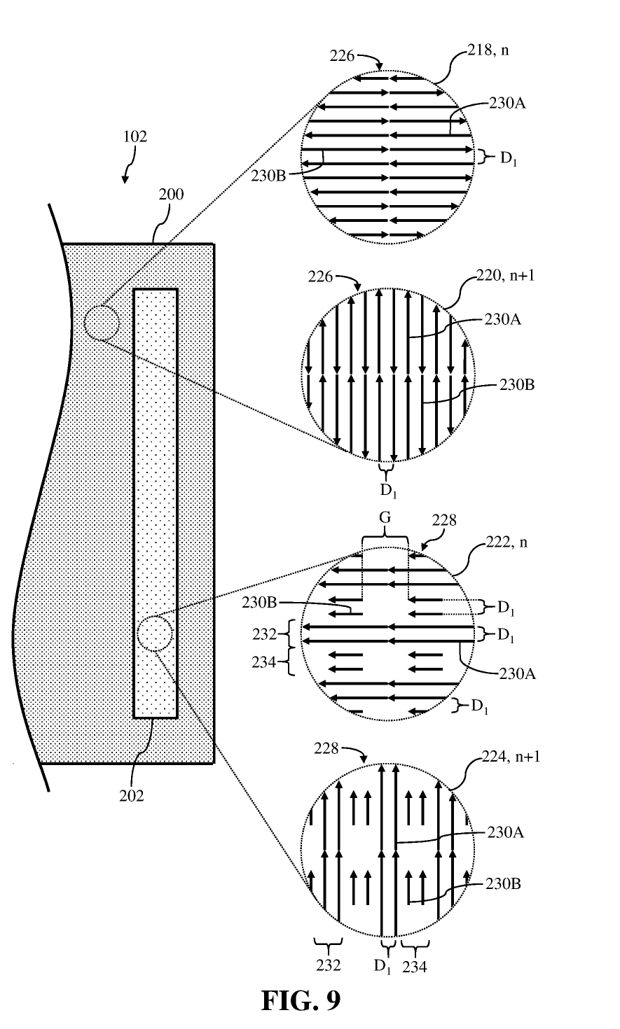

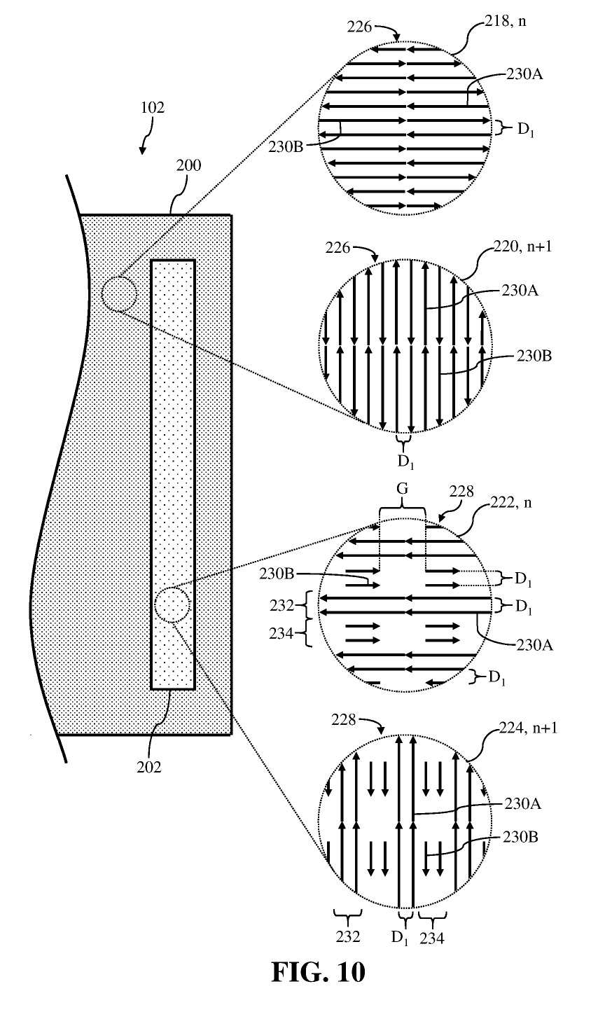

FIGS. 9 and 10 show additional non-limiting examples of second portion 202 of component 102. In the non-limiting examples, second exposure pattern 228 may include segmented scan vectors. More specifically, and as shown in inserts 222, 224, the plurality of scan vectors 230A, 230B of second exposure pattern 228 may include and/or be formed into a plurality of distinct groups 232, 234. In the non-limiting example shown in FIGS. 9 and 10, first group 232 may include two distinct scan vectors 230A, and second group 234 may include two distinct, segmented scan vectors 230B. Segmented scan vectors 230B of second group 234 may be formed by intermittently stopping and starting, or drastically adjusting the build strategy parameters of (e.g., full power to substantially no power), the irradiation beam 160, 162 as irradiation beam 160, 162 and/or irradiation device(s) 110, 112, 114, 116 move in accordance with second exposure pattern 228 as discussed herein. Additionally, and as shown in inserts 222, 224 of FIGS. 9 and 10, each of the segmented scan vectors 230B of second group 234 may be separated by a predetermined gap (G). It is understood that the number of scan vectors 230A, 230B including in first group 232 and/or second group 234, as shown in the figures, may be merely illustrative. As such, each of first group 232 and/or or second group 234 may include more scan vectors 230A, 230B than the number depicted and discussed herein.

In the non-limiting example shown in inserts 222, 224 of FIG. 9, second exposure pattern 228 may include a single direction of movement for first group 232 including scan vectors 230A and second group 234 including scan vectors 230B. That is, second exposure pattern 228 may be formed by maintaining a single direction of movement of irradiation device(s) 110, 112, 114, 116, and/or irradiation beam 160, 162 when following and/or moving in accordance with second exposure pattern 228. For example, and with reference to insert 222 in FIG. 9, first group 232 including scan vectors 230A and second group 234 including segmented scan vectors 230B may be formed by moving irradiation device(s) 110, 112, 114, 116, and/or irradiation beam 160, 162 in the first direction (e.g., right-to-left).

Alternatively in the non-limiting example shown in inserts 222, 224 of FIG. 10, second exposure pattern 228 may include an alternating directional pattern for the plurality of groups 232, 234 of the plurality of scan vectors 230A, 230B. More specifically, second exposure pattern 228 may be formed by alternating the direction of movement of irradiation device(s) 110, 112, 114, 116, and/or irradiation beam 160, 162 when forming first group 232 including scan vectors 230A and second group 234 including scan vectors 230B. For example, and with reference to insert 222, first group 232 including scan vectors 230A may be formed by moving irradiation device(s) 110, 112, 114, 116, and/or irradiation beam 160, 162 in a first direction (e.g., right-to-left). Additionally, second group 234 including segmented scan vectors 230B may be formed by moving irradiation device(s) 110, 112, 114, 116, and/or irradiation beam 160, 162 in a second direction (e.g., left-to-right), distinct from the first.

Also shown in inserts 222, 224 of FIGS. 9 and 10, the plurality of scan vectors 230A, 230B of second exposure pattern 228 may be spaced evenly from one another. Specifically, each of the plurality of scan vectors 230A, 230B included within first group 232 and second group 234, respectively, may be separated from one another by a first distance (D₁). Additionally, scan vector 230A of first group 232 may be separated from scan vector 230B of second group 234 by the first distance (D₁). The first distance (D₁) separating each of the plurality of scan vectors 230A, 230B, and/or first group 232 and second group 234 of second exposure pattern 228 may be substantially equal to the first distance (D₁) separating each of the plurality of scan vectors 230A, 230B of first exposure pattern 226 (see, insert 218; FIGS. 9 and 10).

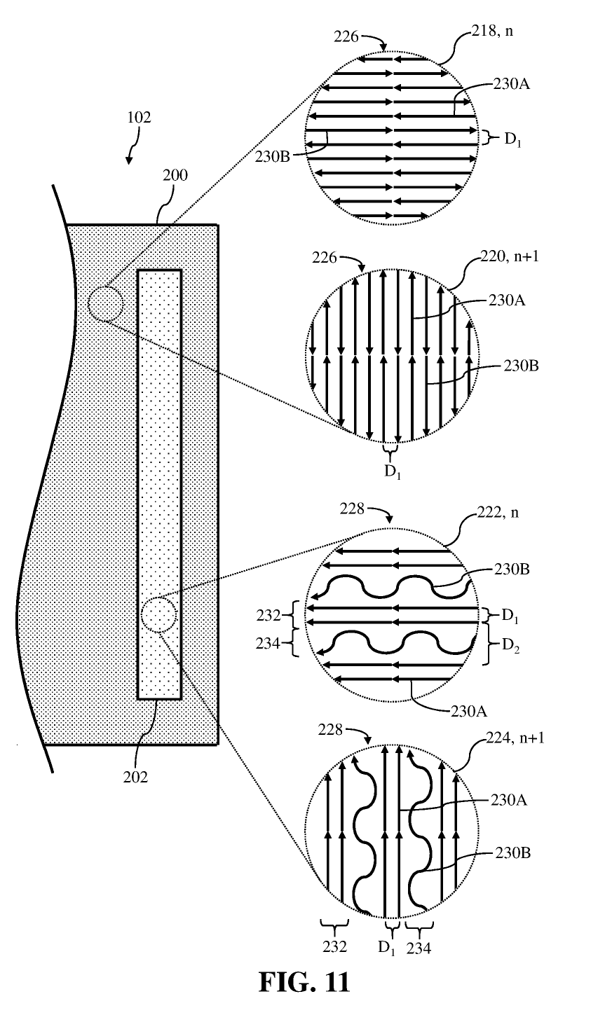

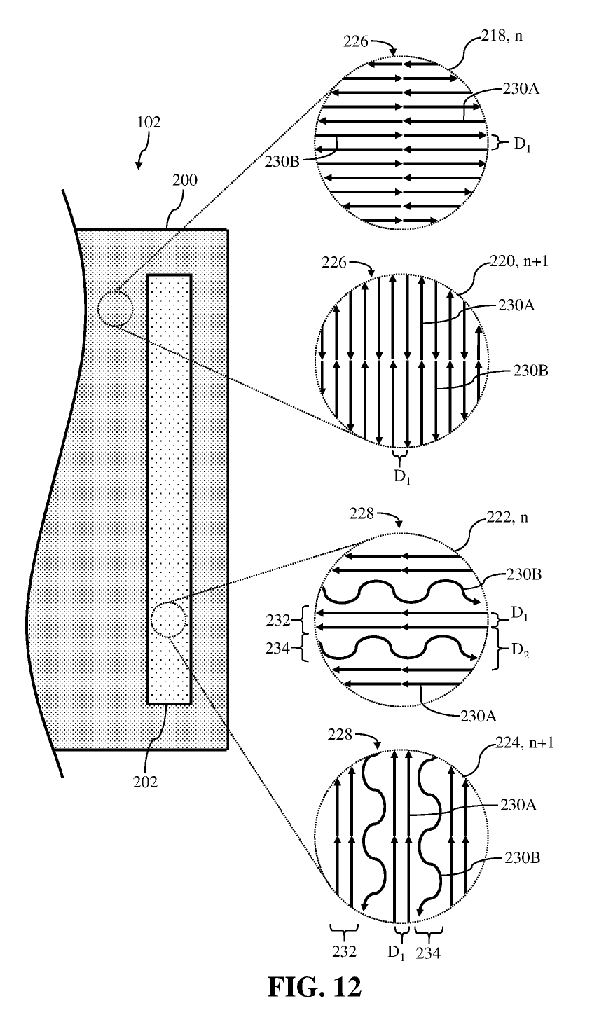

FIGS. 11 and 12 show further non-limiting examples of second portion 202 of component 102. In the non-limiting examples, second exposure pattern 228 may include at least one sinusoidal scan vector. More specifically, and as shown in inserts 222, 224, the plurality of scan vectors 230A, 230B of second exposure pattern 228 may include and/or be formed into a plurality of distinct groups 232, 234. In the non-limiting example shown in FIGS. 11 and 12, first group 232 may include two distinct scan vectors 230A, and second group 234 may at least one sinusoidal scan vector 230B. Sinusoidal scan vectors 230B of second group 234 may be formed by adjusting and/or moving irradiation beam 160, 162 in a sinusoidal pattern, as irradiation beam 160, 162 and/or irradiation device(s) 110, 112, 114, 116 move in accordance with second exposure pattern 228 as discussed herein. It is understood that the number of scan vectors 230A, 230B including in first group 232 and/or second group 234, as shown in the figures, may be merely illustrative. As such, each of first group 232 and/or or second group 234 may include more scan vectors 230A, 230B than the number depicted and discussed herein. For example, second group 234 may include a plurality of sinusoidal scan vectors 230B positioned between distinct first groups 232 of scan vectors 230A.

In the non-limiting example shown in inserts 222, 224 of FIG. 11, second exposure pattern 228 may include a single direction of movement for first group 232 including scan vectors 230A and second group 234 including sinusoidal scan vector 230B. That is, second exposure pattern 228 may be formed by maintaining a single direction of movement of irradiation device(s) 110, 112, 114, 116, and/or irradiation beam 160, 162 when following and/or moving in accordance with second exposure pattern 228. For example, and with reference to insert 222 in FIG. 11, first group 232 including scan vectors 230A and second group 234 including sinusoidal scan vector 230B may be formed by moving irradiation device(s) 110, 112, 114, 116, and/or irradiation beam 160, 162 in the first direction (e.g., right-to-left).

Alternatively in the non-limiting example shown in inserts 222, 224 of FIG. 12, second exposure pattern 228 may include an alternating directional pattern for the plurality of groups 232, 234 of the plurality of scan vectors 230A, 230B. More specifically, second exposure pattern 228 may be formed by alternating the direction of movement of irradiation device(s) 110, 112, 114, 116, and/or irradiation beam 160, 162 when forming first group 232 including scan vectors 230A and second group 234 including sinusoidal scan vector 230B. For example, and with reference to insert 222, first group 232 including scan vectors 230A may be formed by moving irradiation device(s) 110, 112, 114, 116, and/or irradiation beam 160, 162 in a first direction (e.g., right-to-left). Additionally, second group 234 including sinusoidal scan vector 230B may be formed by moving irradiation device(s) 110, 112, 114, 116, and/or irradiation beam 160, 162 in a second direction (e.g., left-to-right), distinct from the first.

Also shown in inserts 222, 224 of FIGS. 11 and 12, the plurality of scan vectors 230A of second exposure pattern 228 may be spaced evenly from one another. Specifically, each of the plurality of scan vectors 230A included within first group 232 may be separated from one another by a first distance (D₁). The first distance (D₁) separating each of the plurality of scan vectors 230A of first group 232 of second exposure pattern 228 may be substantially equal to the first distance (D₁) separating each of the plurality of scan vectors 230A, 230B of first exposure pattern 226 (see, insert 218; FIGS. 11 and 12). Additionally, sinusoidal scan vector 230B of second group 234 may separate scan vectors 230A of two, distinct first groups 234 by a second distance (D₂). The second distance (D₂) may be larger than the first distance (D₁).

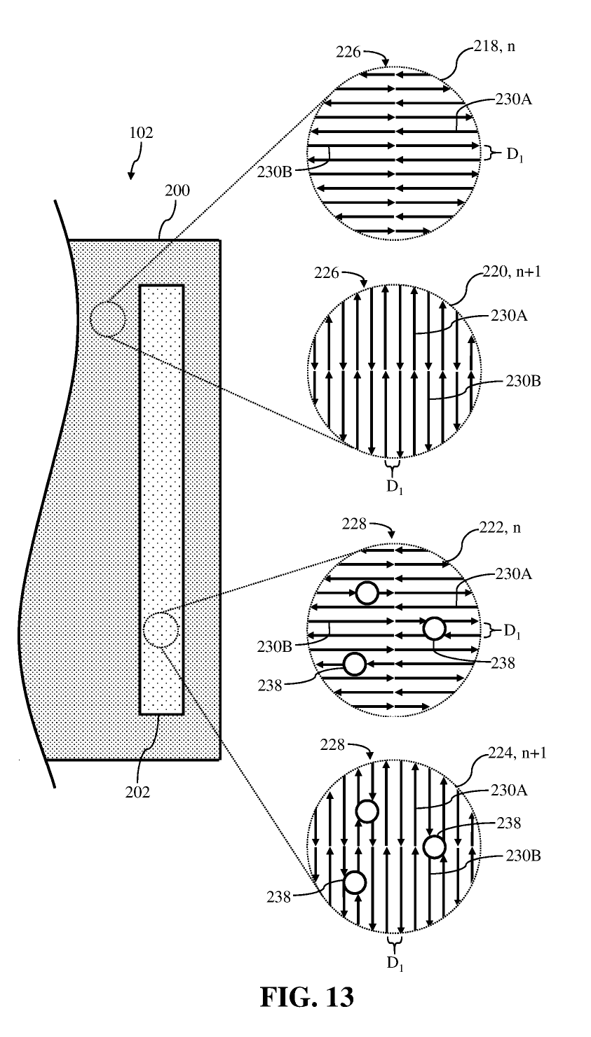

FIG. 13 shows another non-limiting example of component 102 formed by AM system 100. Specifically, FIG. 13 shows a top view of a part of component 102 including first portion 200 and second portion 202. Additionally, and as discussed herein, FIG. 13 shows various inserts showing magnified views of first portion 200 and second portion 202 of component 102. It is understood that similarly numbered and/or named components may function in a substantially similar fashion. Redundant explanation of these components has been omitted for clarity.

As shown in FIG. 13, and more specifically in inserts 222, 224 of FIG. 13, second exposure pattern 228 may include at least one manufactured pore 238 formed therein. That is, second portion 202 including and/or formed using second exposure pattern 228 may include manufactured pore(s) 238 formed through second portion 202. Manufactured pore(s) 238 may be formed at least partially through a depth or height of second portion 202. In a non-limiting example, manufactured pore(s) 238 may be formed at least partially through second portion 202 and may extend only partially through and/or into component 102 including second portion 202. Similar to second exposure pattern 228, and build strategy parameters of second exposure pattern 228, manufactured pore(s) 238 may substantially define the second porosity of second portion 202. For example, as the number and/or size of manufactured pore(s) 238 of second exposure pattern 228 increases, the second porosity of second portion 202 also increases. Also similar to second exposure patterns 228 discussed herein with respect to FIGS. 3-12, manufactured pore(s) 238 increasing the second porosity of second portion 202 may be substantially reduced in size and/or eliminated during a post-build process (e.g., hot isostatic pressing) performed on component 102. The reduction in size and/or elimination of manufactured pore(s) 238 in second portion 202 may ensure that component 102 includes a substantially uniform porosity prior to being used for its intended purpose as discussed herein.

Manufactured pore(s) 238 may be included and/or be formed in second portion 202 using AM system 100 as discussed herein with respect to FIG. 1. More specifically, the build computer file of component 102 (e.g., CAD computer file) and/or the component code 1240 defining component 102 may include manufactured pore(s) 238 formed in second portion 202 of component 102. As such, during the build process, and more specifically when melting raw material 166, second exposure pattern 228 may include manufactured pore(s) 238, and AM system 100 may form manufactured pore(s) 238 in second portion 202 as a result of manufactured pore(s) 238 being included within the build computer file of component 102 (e.g., CAD computer file) and/or the component code 1240 utilized by AM system 100 to build component 102. Manufactured pore(s) 238 may include a predetermined size that may increase the porosity of second portion 202 without decreasing the structural integrity of second portion 202. In non-limiting examples, manufactured pore(s) 238 may be between approximately 0.05 millimeters (mm) and approximately 0.15 mm. Additionally, it is understood that the number of manufactured pore(s) 238 of second exposure pattern 228, as shown in the figures, may be merely illustrative. As such, second exposure pattern 228 may include more or less manufactured pore(s) 238 than the number depicted and discussed herein.

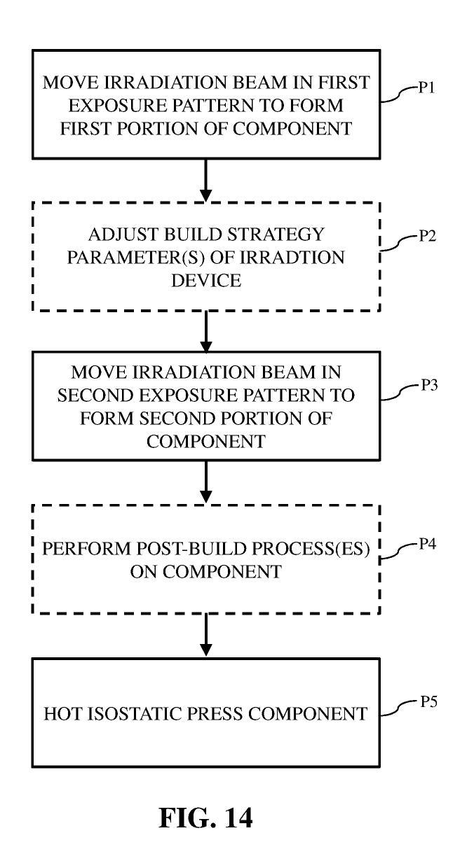

FIG. 14 shows non-limiting example processes for forming a component using an additive manufacturing system. Specifically, FIG. 14 is a flowchart depicting example processes for forming a component including various portions with distinct porosities using an irradiation device of an additive manufacturing system. In some cases, the processes may be used to form component 102, as discussed herein with respect to FIGS. 1-13.

In process P1, an irradiation beam of an irradiation device may be moved in a first exposure pattern. More specifically, the irradiation beam generated by the irradiation device may be moved in a first exposure pattern of a plurality of scan vectors to melt a raw material. Moving the irradiation beam in the first exposure pattern to melt the raw material may form a first portion of the component. The first exposure pattern of the plurality of scan vectors may define a first porosity of the first portion. Moving the irradiation beam in the first exposure pattern may include separating adjacent scan vectors of the plurality of scan vectors for the first exposure pattern by a first distance. Additionally, or alternatively, moving the irradiation beam in the first exposure pattern may include moving the irradiation beam of the irradiation device in a first direction to form a first scan vector of the plurality of scan vectors of the first exposure pattern, and moving the irradiation beam of the irradiation device in a second direction, distinct from the first direction, to form a second scan vector of the plurality of scan vectors of the first exposure pattern.

In process P2 (shown in phantom as optional), at least one build strategy parameter of the irradiation device(s) may be adjusted. That is, build strategy parameter(s) of irradiation device(s) and/or the irradiation beam emitted by irradiation device(s) may be adjusted prior to performing subsequent processes (e.g., process P3 discussed herein). Adjusted build strategy parameter(s) of irradiation device(s) and/or the irradiation beam emitted by irradiation device(s) may include, but are not limited to: the irradiation beam width, speed, power; scan vector length and start/stop positions; irradiation device assignments; scan vector end gap spacing and positioning; and stitching region position, size and shape/path.

In process P3, the irradiation beam of the irradiation device may be moved in a second exposure pattern, distinct from the first exposure pattern of process P1. More specifically, the irradiation beam generated by the irradiation device may be moved in a second exposure pattern of a plurality of scan vectors to melt a raw material. Moving the irradiation beam in the second exposure pattern to melt the raw material may form a second portion of the component, distinct form the first portion. The second exposure pattern of the plurality of scan vectors may define a second porosity of the second portion. The second porosity of the second portion may be distinct from, and more specifically larger than, the first porosity of the first portion. Moving the irradiation beam in the second exposure pattern may include separating adjacent scan vectors of the plurality of scan vectors for the second exposure pattern by a second distance. The second distance separating the plurality of scan vectors for the second exposure pattern may be distinct from, and more specifically larger than, the first distance separating the plurality of scan vectors for the first exposure pattern.

Moving the irradiation beam in the second exposure pattern may include additional processes. For example, moving the irradiation beam in the second exposure pattern may include moving the irradiation beam of the irradiation device in the first direction to form a first group of scan vectors of the plurality of scan vectors of the second exposure pattern, and moving the irradiation beam of the irradiation device in the second direction to form a second group of scan vectors of the plurality of scan vectors of the second exposure pattern. The second group of scan vectors may be formed adjacent the first group of scan vectors. Additionally, or alternatively, moving the irradiation beam in the second exposure pattern may include moving the irradiation beam of the irradiation device in the first direction to form a first group of scan vectors of the plurality of scan vectors of the second exposure pattern, and moving the irradiation beam of the irradiation device in the first direction to form a second group of segmented scan vectors of the plurality of scan vectors of the second exposure pattern. The second group of segmented scan vectors may be separated by a predetermined gap. Moreover, moving the irradiation beam in the second exposure pattern may include moving the irradiation beam of the irradiation device in the first direction to form a first group of scan vectors of the plurality of scan vectors of the second exposure pattern, and moving the irradiation beam of the irradiation device in the first direction to form at least one sinusoidal scan vector of the plurality of scan vectors of the second exposure pattern. Additionally, or alternatively, moving the irradiation beam in the second exposure pattern may include forming at least one manufactured pore in the second portion. The manufactured pore(s) may influence the second porosity of the second portion of the formed component.

In process P4 (shown in phantom as optional), post-build process(es) may be performed on the component. Specifically, and subsequent to moving the irradiation beam in the second exposure pattern to form the second portion of the component, additional post-build process(s) may be performed on the component. Performing the post-build process(es) may including at least one of, polishing the component, shot peening the component, removing the component from a build plate of the additive manufacturing system, and the like.

In process PS, the component may be hot isostatic pressed. More specifically, a hot isostatic pressing process may be performed on the component including the first portion having the first porosity and the second portion having the second porosity that is larger than the first porosity. Performing the hot isostatic pressing on the component may include reducing the second porosity of the second portion of the component by melting and/or transforming any unmelted raw material in second portion and/or the previously melted material forming the second portion. Performing the hot isostatic pressing on the component, and more specifically reducing the second porosity of the second portion of the component, may also include forming the component to include a single, unified porosity. That is, reducing the second porosity of the second portion of the component may include reducing the second porosity of the second portion to equal the first porosity of the first portion of the component.

The technical effect is to provide an intermediate, additive manufactured component including portions having distinct porosities that may substantially minimize and/or eliminate tensile stress within the component when performing build processes.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data. It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufactured component, comprising:
a first portion having a first porosity, the first portion including:
a first exposure pattern of a plurality of scan vectors extending over the first portion, the first exposure pattern defining the first porosity of the first portion; and
a second portion positioned adjacent the first portion, the second portion having a second porosity greater than the first porosity of the first portion, and including:
a second exposure pattern of a plurality of scan vectors extending over the second portion, the second exposure pattern, distinct from the first exposure pattern of the first portion, defining the second porosity of the second portion.

2. The component of claim 1, wherein:
each of the plurality of scan vectors for the first exposure pattern are separated by a first distance; and
each of the plurality of scan vectors for the second exposure pattern are separated by a second distance, the second distance larger than the first distance.

3. The component of claim 1, wherein the plurality of scan vectors for the first exposure pattern include:
a first scan vector formed by moving an irradiation beam of at least one irradiation device of an additive manufacturing system in a first direction; and
a second scan vector formed directly adjacent the first scan vector, the second scan vector formed by moving the irradiation beam in a second direction, distinct from the first direction.

4. The component of claim 3, wherein the plurality of scan vectors for the second exposure pattern include:
a first group of scan vectors formed by moving the irradiation beam in the first direction; and
a second group of scan vectors formed adjacent the first group of scan vectors, the second group of scan vectors formed by moving the irradiation beam in the second direction.

5. The component of claim 3, wherein the plurality of scan vectors for the second exposure pattern include:
a first group of scan vectors formed by moving the irradiation beam in the first direction; and
a second group of segmented scan vectors formed adjacent the first group of scan vectors, the second group of segmented scan vectors separated by a predetermined gap.

6. The component of claim 3, wherein the plurality of scan vectors for the second exposure pattern include:
a group of scan vectors formed by moving the irradiation beam in the first direction; and
at least one sinusoidal scan vector formed adjacent the group of scan vectors.

7. The component of claim 3, wherein the second portion includes at least one pore created in a component code provided to the additive manufacturing system, the at least one pore defining the second porosity of the second portion.

8. An additive manufacturing system, comprising:
at least one irradiation device emitting an irradiation beam to melt a raw material to form a component including:
a first portion having a first porosity; and
a second portion formed adjacent the first portion, the second portion having a second porosity greater than the first porosity; and
at least one computing device operably connected to the at least one irradiation device, the at least one computing device configured to form the component using the at least one irradiation device by performing processes including:
moving the irradiation beam of the at least one irradiation device in a first exposure pattern of a plurality of scan vectors to melt the raw material of the first portion of the component, the first exposure pattern defining the first porosity of the first portion; and
moving the irradiation beam of the at least one irradiation device in a second exposure pattern of a plurality of scan vectors to melt the raw material of the second portion of the component, the second exposure pattern, distinct from the first exposure pattern of the first portion, defining the second porosity of the second portion.

9. The system of claim 8, wherein moving the irradiation beam of the at least one irradiation device in the second exposure pattern further includes:
forming at least one pore in the second portion, the at least one pore created in a component code provided to the at least one computing device to form the component, and
wherein the at least one pore defines the second porosity of the second portion.

10. The system of claim 8, wherein moving the irradiation beam of the at least one irradiation device in the first exposure pattern further includes:
moving the irradiation beam of the at least one irradiation device in a first direction to form a first scan vector of the plurality of scan vectors of the first exposure pattern; and
moving the irradiation beam of the at least one irradiation device in a second direction, distinct from the first direction, to form a second scan vector of the plurality of scan vectors of the first exposure pattern.

11. The system of claim 10, wherein moving the irradiation beam of the at least one irradiation device in the second exposure pattern further includes:
moving the irradiation beam of the at least one irradiation device in the first direction to form a first group of scan vectors of the plurality of scan vectors of the second exposure pattern; and
moving the irradiation beam of the at least one irradiation device in the second direction to form a second group of scan vectors of the plurality of scan vectors of the second exposure pattern, the second group of scan vectors formed adjacent the first group of scan vectors.

12. The system of claim 10, wherein moving the irradiation beam of the at least one irradiation device in the second exposure pattern further includes:
moving the irradiation beam of the at least one irradiation device in the first direction to form a first group of scan vectors of the plurality of scan vectors of the second exposure pattern; and
moving the irradiation beam of the at least one irradiation device in the first direction to form one of:
a second group of segmented scan vectors of the plurality of scan vectors of the second exposure pattern, the second group of segmented scan vectors separated by a predetermined gap, or
at least one sinusoidal scan vector of the plurality of scan vectors of the second exposure pattern.

13. The system of claim 8, wherein the processes performed by the at least one computing device to form the component using the at least one irradiation device further includes:
adjusting an build strategy parameter of the at least one irradiation device prior to moving the irradiation beam of the at least one irradiation device in the second exposure pattern, the build strategy parameter including at least one of:
a speed of movement of the irradiation beam emitted by the irradiation device,
an energy power of the irradiation beam,
a spot size of the irradiation beam, or
a distance between each of the plurality of scan vectors for the second exposure pattern.

14. A method of forming a component using at least one irradiation device of an additive manufacturing system, the method comprising:
moving an irradiation beam of the at least one irradiation device in a first exposure pattern of a plurality of scan vectors to melt a raw material to form a first portion of the component, the first exposure pattern defining a first porosity of the first portion; and
moving the irradiation beam of the at least one irradiation device in a second exposure pattern of a plurality of scan vectors to melt the raw material of a second portion of the component, distinct from the first portion,
wherein the second exposure pattern is distinct from the first exposure pattern of the first portion, and defines a second porosity of the second portion that is greater than the first porosity of the first portion.

15. The method of claim 14, further comprising:
separating adjacent scan vectors of the plurality of scan vectors for the first exposure pattern by a first distance; and
separating adjacent scan vectors of the plurality of scan vectors for the second exposure pattern by a second distance, the second distance larger than the first distance.

16. The method of claim 14, wherein moving the irradiation beam of the at least one irradiation device in the second exposure pattern further includes:
forming at least one pore in the second portion, the at least one pore created in a component code provided to the additive manufacturing system, and
wherein the at least one pore defines the second porosity of the second portion

17. The method of claim 14, wherein moving the irradiation beam of the at least one irradiation device in the first exposure pattern further includes:
moving the irradiation beam of the at least one irradiation device in a first direction to form a first scan vector of the plurality of scan vectors of the first exposure pattern; and
moving the irradiation beam of the at least one irradiation device in a second direction, distinct from the first direction, to form a second scan vector of the plurality of scan vectors of the first exposure pattern.

18. The method of claim 17, moving the irradiation beam of the at least one irradiation device in the second exposure pattern further includes:
moving the irradiation beam of the at least one irradiation device in the first direction to form a first group of scan vectors of the plurality of scan vectors of the second exposure pattern; and
moving the irradiation beam of the at least one irradiation device in the second direction to form a second group of scan vectors of the plurality of scan vectors of the second exposure pattern, the second group of scan vectors formed adjacent the first group of scan vectors.

19. The method of claim 17, wherein moving the irradiation beam of the at least one irradiation device in the second exposure pattern further includes:
moving the irradiation beam of the at least one irradiation device in the first direction to form a first group of scan vectors of the plurality of scan vectors of the second exposure pattern; and
moving the irradiation beam of the at least one irradiation device in the first direction to form on of:
a second group of segmented scan vectors of the plurality of scan vectors of the second exposure pattern, the second group of segmented scan vectors separated by a predetermined gap, or
at least one sinusoidal scan vector of the plurality of scan vectors of the second exposure pattern.

20. The method of claim 14, further comprising:
adjusting a build strategy parameter of the at least one irradiation device prior to moving the irradiation beam of the at least one irradiation device in the second exposure pattern, the build strategy parameter including at least one of:
a speed of movement of the irradiation beam emitted by the irradiation device,
an energy power of the irradiation beam, or
a spot size of the irradiation beam.
